(19) United States
(12) Patent Application Publication
(10) Pub. No.: US 2026/0150042 A1
(43) Pub. Date: May 28, 2026

(54) SYSTEMS AND METHODS TO MAXIMIZE DEVICE BATTERY SAVINGS DURING NON-TERRESTRIAL COMMUNICATION

(71) Applicant: T-Mobile Innovations LLC, Overland Park, KS (US)

(72) Inventors: Roopesh Kumar POLAGANGA, Bothell, WA (US); Meenakshi DHAR, Bellevue, WA (US); Sanjay WAJE, Plano, TX (US)

(21) Appl. No.: 18/958,232

(22) Filed: Nov. 25, 2024

(51) Int. Cl. H04W 52/02; H04B 7/185

(52) U.S. Cl. CPC H04W 52/0225; H04B 7/1851

(57) ABSTRACT

Systems and methods are provided for conserving battery power of a UE during active communication with a non-terrestrial network (NTN) satellite. The systems and methods involve determining that unsupported antennas of the UE are active and deactivating the unsupported antennas. Further, the systems and methods include disabling a beam-sweeping functionality of the beamforming antenna of the UE within the NTN, upon determining the spatial orientation of the UE and adjusting the spatial orientation of the beamforming antenna toward the NTN satellite. In addition, the systems and methods determine that a MIMO functionality of the UE is active in the NTN coverage zone and disable the MIMO functionality of the UE in instances when the MIMO diversity gain is low.

### TECHNICAL BACKGROUND

Despite powerful LTE and 5G wireless networks, well over half a million square miles of the U.S. and vast stretches of ocean are untouched by cell signals. Mobile Network Operators (MNO) have struggled to cover these areas with traditional terrestrial cellular technology, most often due to land-use restrictions (e.g., National Parks), terrain limits (e.g., mountains, deserts, and other topographical realities) and land size. In those areas, people and devices are disconnected, and in scenarios requiring real-time data transmission, the absence of connectivity could lead to critical delays in decision-making and potentially hazardous outcomes.

Certain devices within a network can face intermittent connections that can disrupt essential services and operations. The interruptions can hinder effective operation of the user equipment (UE) during offline periods. When UE reconnects after a period of network unavailability, there is a risk of data loss or corruption during the synchronization process. Maintaining connectivity or searching for available networks can drain the battery life of the UE devices, particularly in areas where network signals are weak. Ensuring that UE can operate effectively during offline periods is of great importance. Robust mechanisms are required to handle data integrity during intermittent connectivity. Efficient energy management strategies are needed to extend the operational lifespan of the UE devices under such conditions.

There is little to no difference on how various antennas within UE radiate power irrespective of whether they are connected to a terrestrial network (TN) or non-terrestrial networks (NTN). However, when UE has an active connection to an NTN satellite, there is a need to save UE's battery while providing service.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts a system of non-terrestrial and terrestrial networks, in accordance with disclosed examples.

FIG. 2 depicts a system of non-terrestrial and terrestrial networks, in accordance with disclosed examples.

FIG. 3 depicts an exemplary system for wireless communication in accordance with various aspects of the present disclosure.

FIG. 4 depicts an exemplary UE in accordance with the disclosed examples.

FIG. 5 depicts an exemplary TN signal enhancement in accordance with the disclosed examples.

FIG. 6 depicts an exemplary interaction between UE and NTN in accordance with the disclosed examples.

FIG. 7 depicts a flowchart illustrating an exemplary method for selective activation of antenna systems, in accordance with the disclosed examples.

FIG. 8 depicts a flowchart illustrating an exemplary method for power efficient beamforming, in accordance with the disclosed examples.

FIG. 9 depicts a flowchart illustrating an exemplary method for adaptive power scaling multiple-input multiple-output (MIMO), in accordance with the disclosed examples.

### OVERVIEW

Various aspects of the present disclosure relate to systems, methods, and computer readable media for deactivating one or more antenna signals to preserve battery of a UE. A method comprises determining that a UE is communicating with an NTN. Responsive to determining the UE is communicating with the NTN, deactivating one or more antenna signals of the UE that are unsupported signals by the NTN to preserve battery of the UE.

In yet another embodiment, the method of managing the PLMN connection comprises adjusting beamforming based on the spatial orientation of the UE relative to the NTN. The method comprises determining that a UE is communicating with an NTN, where the UE includes a plurality of sensors and at least one beamforming antenna. The method comprises determining a spatial orientation of the UE by the plurality of the sensors. The at least one beamform antennas are adjusted based on the spatial orientation of the UE relative to the NTN.

In a further embodiment, a method for determining that a user equipment (UE) is in communication with a non-terrestrial network (NTN) is provided, where the UE comprises a plurality of antennas. The method determines a plurality of signals received at the plurality of antennas satisfy a diversity gain threshold. Responsive to the plurality of signals satisfying a diversity gain threshold, a multiple input multiple output (MIMO) functionality of the UE is adjusted.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the systems and methods described herein, the operations described herein may be implemented as computer-readable instructions or methods, and a processor on the network for executing the instructions or methods. The processor may be an electronic processor included in a UE.

From the middle of Death Valley to the Great Smoky Mountains or even that persistent neighborhood dead zone, satellite mobile service provides a crucial additional layer of connectivity in areas previously unreachable by cell signals from any provider. The combination of an MNO's terrestrial network (TN) and non-terrestrial network (NTN) allows satellite mobile service to work with a regular mobile device and does not require extra equipment such as a separate satellite mobile device. Using a mobile device, even in many of the most remote locations previously unreachable by traditional cell signals, an NTN can provide nearly complete coverage almost anywhere the device has an unobstructed path towards the sky.

A TN and NTN, such as a network of satellites in Earth orbit, combined provide near complete coverage in most places in the U.S. - even in many of the most remote locations previously unreachable by traditional cell signals. The combined TN and NTN can provide UE with text messaging, SMS, MMS, voice and data coverage.

When a UE is in SAT-Mode interacting with a satellite, economic UE battery utilization is paramount. Saving battery can be achieved by minimizing or eliminating unnecessary features/functions of UE. Unnecessary features/functions may include selective activation of a smart antenna system, optimizing beam coverage, and scaling multiple-input multiple-output (MIMO) of the antenna system. Applying any or all of the battery usage optimization techniques can extend the duration of the battery and improve the reliability of UE in the NTN coverage zones.

Turning now to the figures, various devices, systems, and methods in accordance with aspects of the present disclosure will be described.

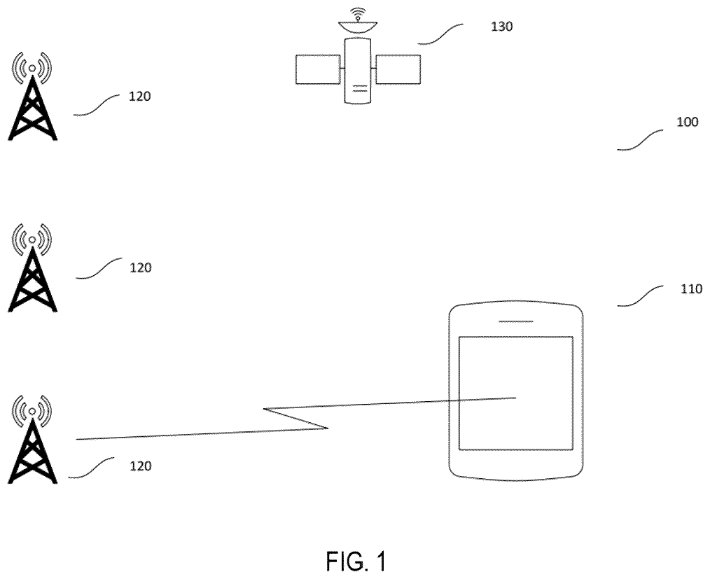

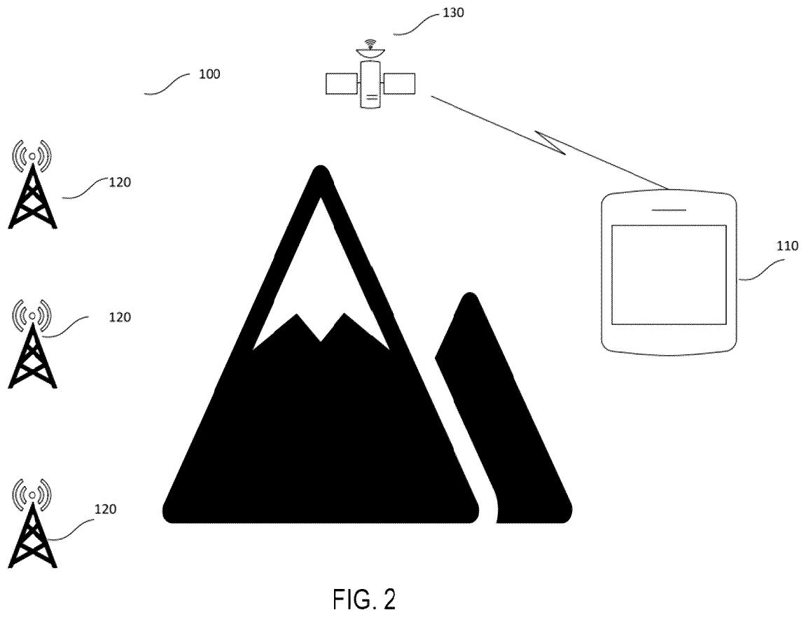

FIGS. 1 and 2 represent system 100 illustrating a combination of a TN and NTN. System 100 includes TN 120 and NTN 130. UE 110 can attach to TN 120 and NTN 130. Moreover, UE 110 may be agnostic whether the device is attached to TN 120 or NTN 130. System 100 is operated by an MNO having a TN 120 and NTN 130. While depicted as a single UE 110, single TN 120 and NTN 130 for illustration, system 100 may comprise multiple UEs 110, TNs 120 and NTNs 130.

TN 120 may be a wireless network, such as a cellular network, and can include a core network and a radio access network (RAN) serving multiple UEs in a geographical area covered by a radio frequency transmission provided by the access network. As technology has evolved, different carriers within the cellular network may utilize different types of radio access technologies (RATs). RATs can include, for example, third generation (3G) RATs (e.g., WCDMA, UMTS, CDMA etc.), fourth generation (4G) RATs (e.g., WiMax, Long Term Evolution (LTE), etc.), and fifth generation (5G) RATs (new radio (NR)) and 6G. Further, different types of access nodes may be implemented within the access network for deployment of the various RATs. For example, an evolved NodeB (eNB) may be utilized for 4G RATs and a next generation NodeB (gNB) may be utilized for 5G RATs. Deployment of the evolving RATs in a network provides numerous benefits. For example, newer RATs may provide additional resources to subscribers, faster communications speeds, and other advantages.

NTN 130 may be a wireless network, such as a cellular network, and can include a core network and a radio access network (RAN) serving multiple UEs by a radio frequency transmission provided by utilizing orbiting satellites that may be in communication with access nodes of TN 120. The satellites may include geosynchronous equatorial orbit (GEO) satellites, Medium Earth Orbit (MEO) satellites, and low Earth orbit (LEO) satellites. The NTN 130 includes NTN nodes that are not stationed on the ground.

The 3rd Generation Partnership Project (3GPP) classifies satellites as part of the Non-Terrestrial Network (NTN), which is considered as a complement to the terrestrial networks. As defined by 3GPP, an NTN may be one of three types of satellite-based next generation radio access network (NG-RAN) architectures: transparent satellite-based NG-RAN, regenerative satellite-based NG-RAN, and multi-connectivity involving satellite-based NG-RAN. Transparent satellite-based NG-RAN implements frequency conversion and a radio frequency amplifier in both uplink and downlink directions. Several transparent satellites may be connected to the same gNB on the ground through New Radio Uplink Unicast (NR-Uu).

Regenerative satellite-based NG-RAN implements regeneration of the signals received from earth. The satellite payload also provides Inter-station Signaling Links (ISL) between satellites. An ISL may be a radio interface or an optical interface that may be 3GPP or non-3GPP defined. The regenerative satellite-based NGRAN architecture may be gNB processed payload (has both gNB Centralized Unit (gNB-CU) and gNB Distributed Unit (gNB-DU)) processed payload. Multi-connectivity involving satellite-based NG-RAN applies to transparent satellites as well as regenerative satellites with gNB or gNB-DU function on board.

The UE 110 can attach to the TN 120 RAN or NTN 130 NG-RAN depending on availability and/or location. The UE 110 remains attached to TN 120 when a TN 120 is available and/or the UE 110 remains within a geofenced area known to have access to the TN 120. The UE110 attaches to the TN 120 for the best quality of service with the TN 120 is available.

As shown in FIG. 2, when the TN 120 is unavailable and/or the UE 110 is outside of a geofenced area known to have access to the TN 120, the UE 110 may attach to the NTN 130. When there is no or limited TN 120 coverage, the UE 110 attaches to the NTN 130. For example, an NTN 130 attachment is advantageous if the UE 110 is located in a known dead zone or cannot access the TN 120.

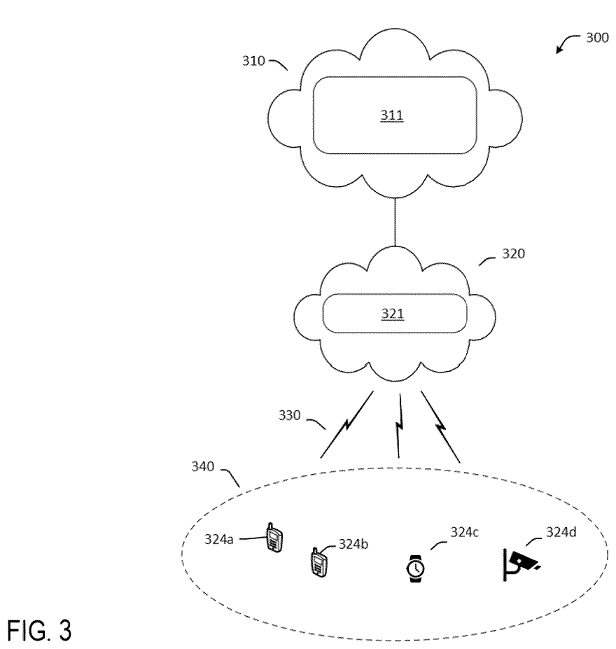

FIG. 3 depicts an exemplary system 300 for wireless communication, in accordance with the disclosed embodiments. The system 300 may include a core network 310, NTN RAN 320 and multiple UEs 324a-d able to communicate within the network, such as TN, NTN or a combination of the TN and the NTN.

UEs 324a-d may be any device, system, combination of devices, or other such communication platform capable of communicating on the wireless network using one or more frequency bands deployed therefrom. UEs 324a-d may be divided into two categories for the purposes of this disclosure. UEs 324a-d may be eMBB devices and may be, for example, mobile phones, wireless phones, cellular home internet modems, personal digital assistants (PDA), tablet computers, as well as other types of devices or systems that can exchange audio or data via the wireless network as non-reduced capability devices. UEs 324a-d may be reduced capability (RedCap) devices and may include smart watches and other wearables, industrial sensors, and video surveillance equipment, for example. Other types of communication platforms are possible.

UEs 324a-d may be end-user wireless devices and may operate within one or more coverage areas 340 and communicate with the NTN RAN 320 over communication links 330. The core network 310 includes core network functions and devices 311. The core network may be structured using a service-based architecture (SBA).

The NTN RAN 320 may include various RAN systems and devices 321. The RAN systems and devices 321 are disposed between the core network 310 and the UEs 324a-d. Some of the RAN systems and devices 321 may communicate directly with the core network 310 and others may communicate directly with the UEs 324a-d. Other RAN systems and devices 321 may communicate with one another within the RAN in order to provide services from the core network 310 to the UEs 324a-d.

The NTN RAN 320 includes at least an access node (or base station) communicating with a plurality of UEs. It is understood that the disclosed technology may also be applied to communication between a UE and other network resources, such as relay nodes, controller nodes, antennas, etc. Further, multiple access nodes may be utilized.

System 300 may further include many components not specifically shown in FIG. 3 including processing nodes, controller nodes, routers, gateways, and physical and/or wireless data links for communicating signals among various network elements. System 300 may include one or more of a local area network, a wide area network, and an internetwork (including the Internet). System 300 may be capable of communicating signals and carrying data, for example, to support voice, push-to-talk, broadcast video, and data communications by UEs 324a-d.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 300 may be, comprise, or include computers systems and/or processing nodes.

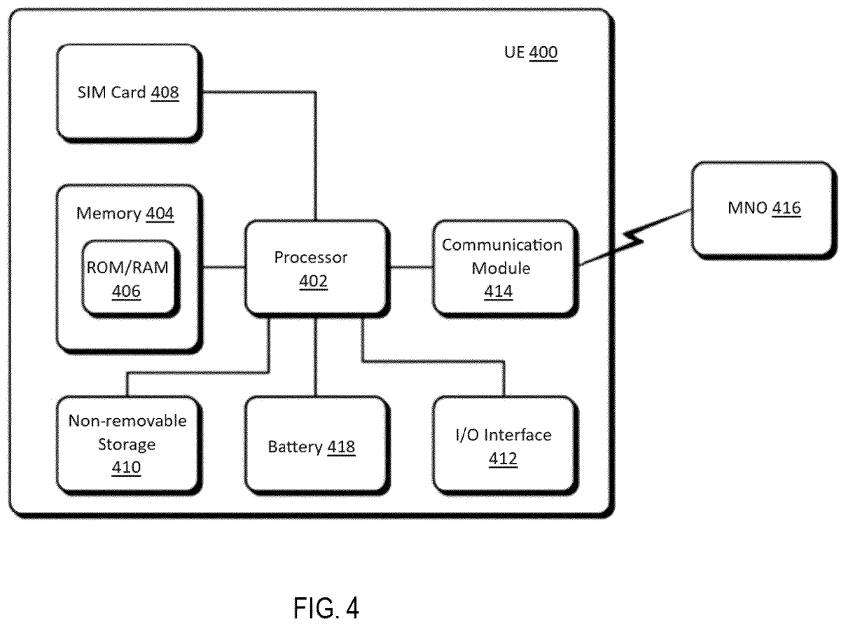

FIG. 4 illustrates an example block diagram of a UE. The UE 400 may include one or more processors 402 and memory 404 coupled to the one or more processors 402. In some examples, the one or more processors 402 may be a central processing unit (CPU), a graphics processing unit (GPU), or both CPU and GPU, or other processing unit or component known in the art. Memory 404 may include volatile memory (such as random-access memory (RAM)) and/or non-volatile memory (such as read-only memory (ROM), flash memory, etc.) 406. The UE 400 may include SIM 408 coupled to the one or more processors 402, and non-removable storage 410 including, but not limited to, flash memory, magnetic storage, optical storage, and/or tape storage that may provide non-volatile storage of computer readable instructions, data structures, program modules, and other data for the UE 400.

The UE 400 may include an Input/Output (I/O) interface 412 coupled to the one or more processors 402 and may include a touch screen, microphone, and the like, configured to receive information from a user, and may include an audio output. The display is configured to provide an output for the user. The UE 400 may include a communication module 414 coupled to the one or more processors 402 and configured to wirelessly communicate with a MNO 416. The communication module 414 may be configured to wirelessly communicate with a an NTN, for example. The communication module 414 may include one or more antenna systems that transmit and receive wireless signals.

The UE 400 may also include battery 418 configured to power all components of the UE 400. When the UE 400 is in SAT-Mode interacting with the NTN, for example, economic utilization of battery 418 is achieved by minimizing or eliminating unnecessary features/functions of UE 400. The minimizing of features may include selective activation of a smart antenna system, optimizing beam coverage, scaling MIMO of the antenna system. Applying any or all of the battery usage optimization techniques can enhance the performance of the battery 418 and improve the reliability of the UE 400 in the NTN coverage zones.

### Antenna System With Selective Activation

In one embodiment, the antenna signals of the communication module 414 are selectively activated or deactivated when interacting with one or more wireless networks of the MNO. In one embodiment, the NTN communication is long-term evolution (LTE) wireless broadband communication without 5G wireless communication. As such, several antenna signals are not available to the UE 400. The communication module 414 of the UE 400 will consume energy actively searching for unavailable signals.

Selective activation of the antennas may involve dynamically turning on or off specific antennas or antenna elements of a UE based on network conditions, user requirements, and/or environmental factors during communication with the NTN. In one example, selective activation/deactivation of the antennas is performed by satellite provided selective activation instructions, and in another instance, the selective antenna activation/deactivation is based on selective activation instructions input or pre-loaded in the UE 400. Selective activation may reduce power consumption by deactivating antennas that are not needed, thereby conserving energy and improving the performance of the battery 418. In one embodiment, selective activation can extend battery life by reducing the power usage of the radio transceivers.

The antenna signals may include WiFi antennas, millimeter-wave (mmWave) antennas, new radio (NR) antennas, cellular antennas, Bluetooth antennas, near field communication (NFC) antennas, wireless gigabit (WiGig) antennas, internet of things (IoT) antennas, etc. Other advanced antennas, such as NR antennas may include beamforming antennas that focus the wireless signal in a specific direction to improve signal strength, MIMO antennas that utilize a large number of antennas to serve multiple UEs simultaneously, increasing capacity and spectral efficiency, adaptive antennas that dynamically adjust their pattern and gain to optimize performance based on the environment and UE location, etc.

In one embodiment, the antenna signals may include the band/layer of communication between the UE 400 and the NTN. The less stringent timing alignment requirements of FDD compared to TDD may render FDD bands preferred, and as a result, the TDD antenna signal may be disabled.

### Power Efficient Beamforming

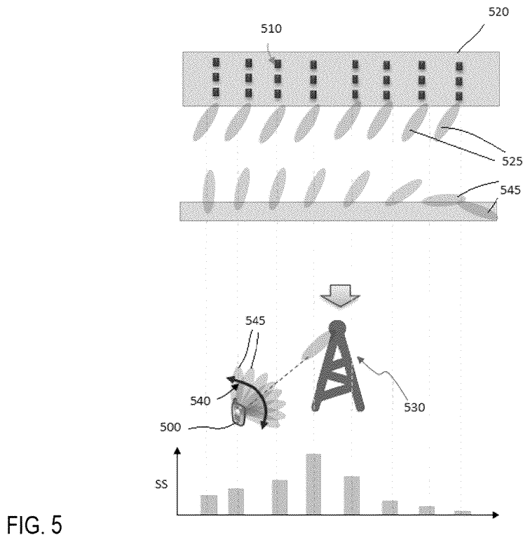

In the embodiment shown in FIG. 5, UE 500 and access node 520 are configured for beamforming. The UE 500 and access node 520 include multiple antennas 510 which are arranged in an array that work together to shape the directionality of the antenna signals (beams) 525. The beamforming may be performed by multiple antennas 510 arranged in an array 520.

### Power Efficient Beamforming

In the embodiment shown in FIG. 5, UE 500 is configured to transmit and receive antenna signals directed via beamforming. The beamforming may be performed by multiple antennas arranged in an array. The antennas may work together to shape the directionality of the signal. Multiple transmitting and receiving points (TRP) 510 are radio units within access nodes 520 that are a part of the radio access network (RAN) and are capable of communicating with the UE 500. The TRPs 510 may be used to enhance coverage, capacity, and reliability in certain 5G networks.

As shown in FIG. 5, each network 530 may transmit signal (Tx) beams 525 that point in the same direction in the course of time. At the same time, the UE 500 may include multiple antennas, which are arranged in an array that work together to shape the directionality of the signal. By adjusting the phase and amplitude of the signals at each antenna in the array, the combined signal can be directed towards a particular direction.

If the UE 500 is changing locations, it performs an ongoing search for the best signal by performing beam sweeping 540 by periodically or sequentially changing direction of receiver (Rx) beams 545 to communicate with different networks 530. The beam sweeping 540 can be done by scanning or changing angles of the beams 545 either in a predetermined pattern or dynamically based on the communication requirements. As the (Rx) beams 545 best align with the (Tx) beams 525 and UE 500 locks in the alignment with the strongest signal until the signal strength drops. However, ongoing beam sweeping 540 consumes the power of the battery the UE 500.

In an NTN, there is no need for a UE 500 to radiate antenna power across all the spatial directions. UE 500 can conserve battery power by disabling the beam sweeping function, and by focusing the energy vertically towards sky to save energy. In some instances, NTN communication is long-term evolution (LTE) wireless broadband communication, with no 5G wireless communication available for example, and beamforming/beam sweeping may not be beneficial to the UE 500 to spend energy actively scanning for beams.

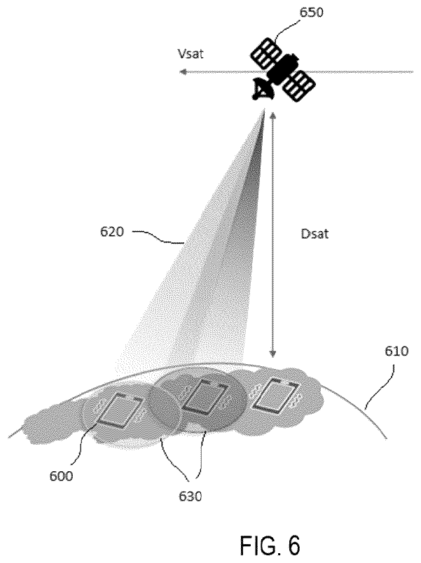

As shown in FIG. 6, the NTN satellite 650 can orbit at a distance Dₛₐₜ of several hundreds of miles from the surface of the Earth 610, e.g., approximately 350 miles, moving respective to the Earth 610 at a velocity Vₛₐₜ of tens of thousands of miles per hour, e.g., 17,000 miles per hour. At such distances from the Earth 610, the satellite 650 may form signal beams 620 and transmit the beams 620 to the UEs 600 in NTN coverage zones 630. In certain embodiments, the NTN coverage zones 630 may be multiple times greater in area than typical TN coverage zones, for example, 10-50 time greater than the TN coverage zones. For example, one beam 620 may cover a 60 mile wide grid. A typical L-band TN site may be 10 miles wide, where the land is barren with minimal obstructions such as buildings and foliage, or as low as 2 miles wide in urban areas or mountainous terrain. With the disproportionately larger NTN coverage zones 630, the location of the UEs 600 within the zone is not as significant as within the TN coverage areas. As a result, the alignment of the angles between the UE beams and the NTN beams 620 would not be essential, and, therefore, the beam sweeping may be unnecessary. For example, in such a scenario, the slight improvement of the signal from the satellite 650 is outweighed by the downside of the battery power consumption from continuous beam sweeping.

With continued reference to FIG. 6, an exemplary power efficient beamforming approach is provided as antenna power from a UE is not necessary across all spatial directions in an NTN. Using the power efficient beamforming approach, a UE focuses energy vertically towards the sky and avoids using other beams/beam-sweeping to save energy.

The power efficient beamforming approach gathers sensor data including global position system (GPS) data, gyroscope data, accelerometer data, and magnetometer data. The GPS obtains the current geographic location of the UE. The gyroscope measures the UE's current orientation for pitch, roll and yaw. The accelerometer determines the direction of gravitational pull to establish “up” or the direction toward the sky for the UE. The magnetometer determines the heading of the UE relative to magnetic north.

Such data is used to calculate the orientation of the UE 600. The calculations utilize data fusion techniques to combine data from the GPS sensor, accelerometer, gyroscope, and magnetometer to compute the three-dimensional orientation of the UE 600. In addition, a vertical axis of the UE 600 is determined by establishing the device's skyward direction based on the accelerometer (gravity direction) and gyroscope data.

Once the vertical axis and orientation are ascertained, the UE 600 antennas are adjusted for beamforming. Specifically, the UE 600 antennas may be configured so that beamforming is set to a general skyward direction. In one embodiment, the beamforming antennas are configured to focus energy in the upward direction.

As the interaction between the UE 600 and the satellite 650 is monitored and adapted as necessary. In particular, a feedback loop may be created to continuously monitor the signal strength and quality. In instance when the signal improvement is warranted, the strength or the direction of the beams are dynamically adjusted based on the feedback to maximize the likelihood of satellite 650 acquisition.

### Adaptive Power Scaling MIMO

With continued reference to FIG. 6, UE 600 can be configured to use MIMO communication. MIMO may increase the capacity and reliability of data transmission by using multiple antennas at both the transmitter and receiver ends to exploit multipath propagation. For example, a 2×2 MIMO system has two antennas at the transmitter and two at the receiver. Signals may travel from the transmitter to the receiver along multiple paths due to reflections, refractions, and scattering from topography and buildings. MIMO systems may take advantage of these multiple paths to improve communication performance. The usage of multiple antennas, such as MIMO, for transmitting and receiving considerably depletes the battery of the UE 600.

With continued reference to FIG. 6, an adaptive power scaling MIMO approach is provided. Using the adaptive power scaling MIMO approach, MIMO settings are dynamically adjusted to save UE energy.

The adaptive power scaling MIMO approach gathers data regarding applications allowed/used by UE 600, active band/layer being used, evaluates if multiple antennas receive different signal patterns, and battery level of UE 600. Once the data is gathered, if a diversity gain threshold is satisfied, the UE 600 MIMO is adjusted. Specifically, the UE 600 MIMO may be configured to turn off MIMO to save battery if it is not necessary for communication between the UE 600 and satellite 650. In one embodiment, MIMO is disabled if UE 600 is using low data applications such as text. In another embodiment, MIMO is enabled if the active band/layer for communication between UE 600 and satellite 650 utilizes MIMO. In another embodiment, MIMO is enabled if multiple antennas receive significantly different signal patterns in order to evaluate the benefit of the two-layer redundancy.

In embodiments, the adaptive power scaling MIMO approach uses a feedback loop to periodically check for the signal quality and data type during communication between UE 600 and satellite 650. If the signal is below acceptable level or high-data applications are being used, the system adjusts MIMO settings dynamically based on real-time data and battery level. In one embodiment, if the battery power level is determined to be sufficient, and the signal quality is inadequate (or required throughput is high), the MIMO capability may be reenabled. The feedback loop may be active as long as the UE 600 is in the SAT-mode. In embodiments, when UE 600 exits the SAT-mode, the MIMO functionality may be turned back on.

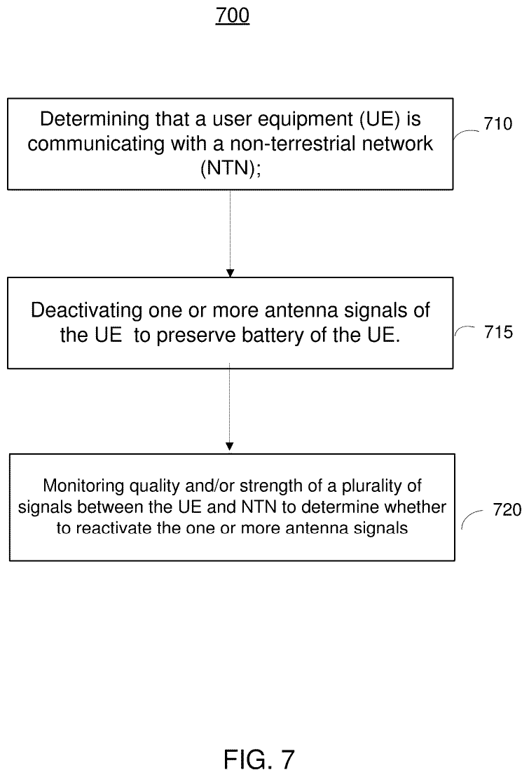

FIG. 7 depicts a flowchart 700 illustrating an exemplary method for selective activation/deactivation of antenna signals, in accordance with the disclosed examples. The steps of the flowchart can be performed by pre-loading the UE 400 shown in FIG. 4 with instructions to selectively activate or deactivate different antenna signals, or, in the alternative, the UE 400 can receive instructions from a TN or NTN. In instances when the UE 400 is updated, the device may pull the update from an NTN server, or the server can push the instructions to the UE 400 to initiate the update.

At operation 710, the system checks whether the UE 400 is connected to an NTN (e.g., SAT-mode).

If it is determined that the UE is connected to the NTN, at operation 715, one or more antenna signals of the UE are deactivated to preserve battery of the UE. In embodiments, antenna signals that are unsupported/irrelevant to communication between the UE and NTN are deactivated. The antenna signals that are unsupported/irrelevant to communication with the NTN may include WiFi antennas, millimeter-wave (mmWave) antennas, new radio (NR) antennas, cellular antennas, Bluetooth antennas, near field communication (NFC) antennas, wireless gigabit (WiGig) antennas, internet of things (IoT) antennas, etc. Other advanced antennas signals, such as NR antennas may include beamforming antennas that focus the wireless signal in a specific direction to improve signal strength and MIMO antennas that utilize a large number of antennas to serve multiple UEs simultaneously, and adaptive antennas that dynamically adjust their pattern and gain to optimize performance based on the environment and UE location.

In embodiments, the UE 400 can be configured to disable the antenna signals once NTN communication is detected. Alternatively, UE 400 may be configured to receive instructions from the NTN to turn off unsupported/irrelevant antenna signals. Exemplary antenna signals may be WIFI signals, mmWave signals, NR antennas, Bluetooth antenna, and/or the NFC antenna. WIFI and mmWave are short range signals typically not used by NTN. NR antennas provide high-speed internet access for applications like streaming, gaming, and virtual reality. The upside of the benefits provided by the NR antennas for video streaming, gaming and virtual reality is outweighed by the downside of the excessive power consumption and significant heat generation of the NR antennas.

The antenna signals may include unpreferred frequency bands. In one embodiment, frequency division duplex (FDD) and time division duplex (TDD) can be used to separate uplink and downlink signals. FDD may use different frequency bands for uplink from UE 400 to the NTN and downlink from the NTN to UE 400. TDD, on the other hand, may use a single frequency band for both uplink and downlink transmissions, which are then separated by time slots within the same frequency band. The less stringent timing alignment requirements of FDD compared to TDD may render FDD bands preferred when using an NTN, and as a result, at operation 715, the TDD antenna signals may be deactivated or disabled. Any number and type of antenna signals may be disabled to preserve the battery of the UE.

At operation 720, a feedback loop is performed, the quality and/or strength of a plurality of signals between the UE and NTN are monitored to determine whether to reactivate the one or more antenna signals the resulting signal is satisfactory in strength and quality. For example, the UE 400 may require improved antenna signal reception due to renewed availability and benefit of the antenna signals, such as the signals disabled at operation 715. In one embodiment, the disabled antenna signals may become available because the UE 400 reenters a TN coverage zone. Therefore, at operation 715, some of or all of the deactivated antennas may be turned back on, and the system may recheck for an active connection to an NTN anew at operations 710.

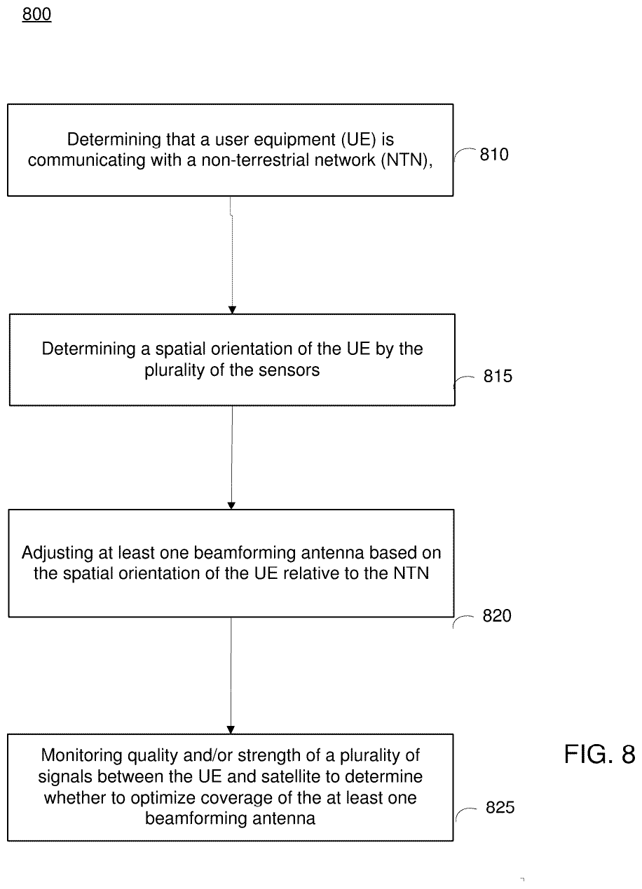

FIG. 8 depicts a flowchart 800 illustrating an exemplary method for power efficient beamforming, in accordance with the disclosed examples. For example, the UE 600 shown in FIG. 6 may be initially configured to transmit and receive signals directed via beamforming. Further, the UE 600 configured for TN may perform beam sweeping by periodically or sequentially changing one or more directions of Rx beams to communicate with different TNs. The ongoing sweeping may needlessly consume the power of the battery of the UE 600 device in case the UE 600 communicates with an NTN satellite.

At operations 810, it is determined whether UE 600 is connected to an NTN, e.g., in communication with the NTN.

At operations 815, if the UE is in communication with the NTN, the spatial orientation of the UE relative to the NTN is determined by utilizing data form a plurality of sensors. The sensor data is processed to calculate the orientation of the UE 600. The integration of the data may involve data fusion techniques to combine inputs from a GPS sensor, accelerometer, gyroscope, and magnetometer to compute the device's three-dimensional orientation. In addition, a vertical axis of the UE 600 may be determined by establishing the device's skyward direction based on the accelerometer (gravity direction) and gyroscope data.

Once the vertical axis is ascertained, at operations 820, the UE 600 antennas may be adjusted for beamforming based on the spatial orientation of the UE relative to the NTN. Specifically, the antennas may be configured so that beamforming is set to a general skyward direction. In one embodiment, the beamforming antennas are configured to focus energy in the upward direction. Performing the measurements by the sensors, such as gyroscope, accelerometer, and magnetometer, to acquire data used for computing the vertical direction may substitute the energy-wasteful beam sweeping to find the optimal (vertical) alignment with the satellite 650; hence, the UE's battery performance can be improved.

As the interaction between the UE 600 and the satellite 650 is confirmed, at operations 825 the connection is monitored and adapted as necessary. In particular, a feedback loop may be created to continuously monitor the signal strength and quality. In instance when the signal improvement is warranted, the strength or the direction of the beams 620 can be adjusted based on the feedback to optimize coverage of one or more UE 600 antennas in order to maximize the likelihood of the acquisition of the satellite 650 signal.

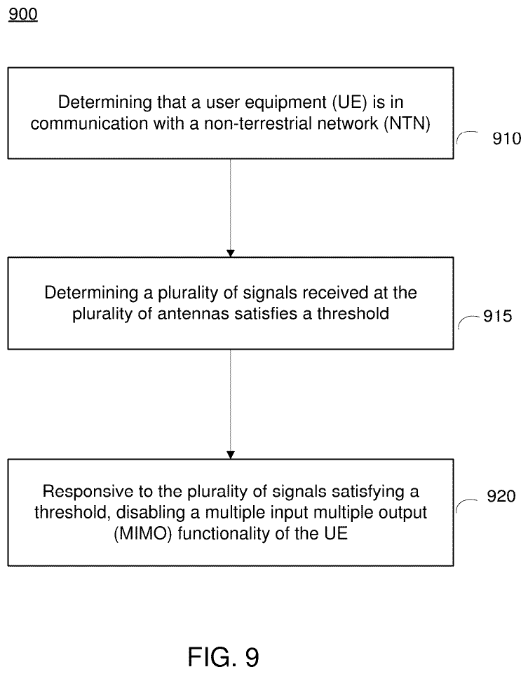

FIG. 9 depicts a flowchart 900 illustrating an exemplary method for adaptive power scaling MIMO, in accordance with the disclosed examples. At operations 910, the system checks whether there is an active connection between the UE and an NTN satellite such that the UE is in communication with the NTN.

In instances when the UE 600 communicates with the satellite 650, such as in remote and secluded areas, efficient power consumption may be of importance. At the same time, due to the substantially vertical communication between the UE 600 and the satellite 650, reflections, refractions, and scattering of the signal are less likely than with TN. Therefore, the UE 600 may be configured to the selected MIMO function, in order to determine whether the significant battery power consumption is justified.

At operations 920, when UE 600 is in connection with the NTN, the system determines whether a plurality of signals of the UE satisfy a diversity gain threshold. In embodiments, the diversity gain threshold comprises a predetermined amount of correlation between the plurality of signals received at the plurality antenna indicating that the signals are experiencing different fading and interference effects. A high-correlation among the plurality of signals received at the at least one of the plurality of antennas indicates absence of a diversity gain of the MIMO functionality.

If the plurality of signals satisfies a diversity gain threshold, multiple input multiple output (MIMO) functionality of the UE is disabled or adjusted to save battery. Specifically, the UE 600 may be configured to turn off MIMO to save battery if diversity gain is not necessary for communication between the UE 600 and satellite 650. In one embodiment, MIMO is disabled if UE 600 is using low data applications such as text messaging, SMS, and MMS applications, and does not need diversity gain. In another embodiment, MIMO is enabled if the active band/layer for communication between UE 600 and satellite 650 utilizes MIMO and diversity gain will improve communication between UE 600 and satellite 650. In another embodiment, MIMO is enabled if multiple antennas receive significantly different signal patterns in order to evaluate the benefit of the two-layer redundancy. responsive to the plurality of signals satisfying a diversity gain threshold, adjusting a multiple input multiple output (MIMO) functionality of the UE. In embodiments, the adaptive power scaling MIMO approach uses a feedback loop to periodically check for the signal quality and data type during communication between UE 600 and satellite 650. If the signal is below acceptable level or high-data applications are being used and diversity gain would improve communications between the UE 600 and satellite 650, the system adjusts MIMO settings dynamically based on real-time data and battery level. In one embodiment, if the battery power level is determined to be sufficient, and the signal quality is inadequate (or required throughput is high) and diversity gain would improve communications between the UE 600 and satellite 650, the MIMO capability may be reenabled. The feedback loop may be active as long as the UE 600 is in the SAT-mode. In embodiments, when UE 600 exits the SAT-mode, the MIMO functionality may be turned back on.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

1. A method, comprising:
determining that a user equipment (UE) is communicating with a non-terrestrial network (NTN); and
responsive to determining the UE is communicating with the NTN, deactivating one or more antenna signals of the UE that are unsupported signals by the NTN to preserve battery of the UE.

2. The method of claim 1, periodically checking for quality and/or strength of a plurality of signals transmitted and/or received by the UE to determine whether to reactivate the one or more antenna signals.

3. The method of claim 1, wherein the determination that the UE is communicating with an NTN includes determining whether the UE is in a satellite mode (SAT-mode).

4. The method of claim 1, wherein the one or more antenna signals is at least one of WiFi signals, millimeter-wave (mmWave) signals, new radio (NR) signals, cellular signals, Bluetooth signals, near field communication (NFC) signals, wireless gigabit (WiGig) signals, internet of things (IoT) signals, new radio (NR) signals, and multiple-input multiple-output (MIMO) signals.

5. The method of claim 1, wherein the unsupported signals by the NTN include unpreferred frequency band signals and supported signals by the NTN include preferred frequency band signals.

6. The method of claim 5, wherein the unpreferred frequency band signals comprise time division duplex (TDD) signals, and the preferred frequency band signals comprise frequency division duplex (FDD) signals.

7. The method of claim 1, wherein the UE includes a plurality of sensors indicative of spatial orientation of the UE and at least one beamforming antenna, the method further comprising:
disabling a beam-sweeping functionality of the at least one beamforming antenna of the UE;
acquiring data by the plurality of the sensors indicative of the spatial orientation of the UE;
processing the data acquired by the plurality of the sensors to compute the spatial orientation of the UE; and
adjusting the spatial orientation of the at least one beamforming antenna.

8. A method comprising:
determining that a user equipment (UE) is communicating with a non-terrestrial network (NTN), wherein the UE includes a plurality of sensors and at least one beamforming antenna;
determining a spatial orientation of the UE by the plurality of the sensors; and
adjusting the at least one beamforming antenna based on the spatial orientation of the UE relative to the NTN.

9. The method of claim 8, further comprising periodically checking for quality and/or strength of signals transmitted and/or received by the UE to determine whether to optimize coverage of the at least one beamforming antenna.

10. The method of claim 9, wherein the determination that the UE is communicating with the NTN includes determining whether the UE is in a satellite mode (SAT-mode).

11. The method of claim 9, wherein the plurality of sensors indicative of the spatial orientation of the UE are at least one of a GPS sensor, a gyroscope, an accelerometer and a magnetometer.

12. The method of claim 7, wherein the beam-sweeping functionality of the at least one beamforming antenna comprises persistent angle changing of the at least one beamforming antenna to scan for a best alignment with beams transmitted by the NTN.

13. The method of claim 9, wherein the spatial orientation of the UE comprises determining a vertical axis of the UE towards an NTN satellite.

14. The method of claim 13, wherein the spatial orientation of the at least one beamforming antenna is a vertical orientation aligned with the determined vertical axis of the UE.

15. The method of claim 14, wherein the optimized coverage of the at least one beamforming antenna comprises adjusting a strength and/or a direction of the at least one beamforming antenna based on feedback information regarding the quality and/or strength of the signals.

16. The method of claim 7, the method further comprising
determining that the UE uses low-data applications;
determining that a multiple-input multiple-output (MIMO) functionality of the UE is active;
determining high-correlation among the plurality of signals received at least one of a plurality of antennas;
disabling the MIMO functionality of the UE; and
periodically checking for quality and/or strength of the plurality of signals transmitted and/or received by the UE to determine whether to reactivate the MIMO functionality.

17. A method comprising:
determining that a user equipment (UE) is in communication with a non-terrestrial network (NTN), wherein the UE comprises a plurality of antennas;
determining a plurality of signals received at the plurality of antennas satisfies a threshold; and
responsive to the plurality of signals satisfying a diversity gain threshold, adjusting a multiple input multiple output (MIMO) functionality of the UE.

18. The method of claim 16, wherein the low-data applications comprise at least one of text messaging, SMS, and MMS applications.

19. The method of claim 17, wherein the diversity gain threshold comprises a predetermined amount of correlation between the plurality of signals received at the plurality antenna indicating that the signals are experiencing different fading and interference effects.

20. The method of claim 19, wherein a high-correlation among the plurality of signals received at the at least one of the plurality of antennas indicates absence of a diversity gain of the MIMO functionality.
